(19) United States
(12) Patent Application Publication
(10) Pub. No.: US 2006/0079235 A1
(43) Pub. Date: Apr. 13, 2006

(54) System and method for handover in a broadband wireless access communication system

(75) Inventor: Gwang-Eun Kim, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/248,994

(22) Filed: Oct. 12, 2005

(30) Foreign Application Priority Data
Oct. 12, 2004 (KR) 81419/2004

(51) Int. Cl. H04Q 7/20

(52) U.S. Cl. 455/439; 455/436

(57) ABSTRACT

A system and a method for performing a handover in a broadband wireless access communication system including a serving BS, target BSs adjacent to the serving BS, and the MS currently communicating with the serving BS. The method includes receiving neighbor ranging code information from the serving BS, transmitting the neighbor ranging code information to at least one target BS, and receiving information for the handover from the serving BS.

### PRIORITY

This application claims the benefit under 35 U.S.C. 119(a) of an application entitled “System and Method For Handover In A Broadband Wireless Access Communication System” filed with the Korean Intellectual Property Office on Oct. 12, 2004 and assigned Serial No. 2004-81419, the contents of which are incorporated herein by reference.

### BACKGROUND OF THE INVENTION

1. Field of the Invention

The present invention relates generally to a broadband wireless access communication system, and more particularly to a system and a method for a handover of a mobile station in a broadband wireless access communication system.

2. Description of the Related Art

Recently, various studies and research have been actively carried out in relation to broadband wireless access communication systems, i.e., 4^{th} generation (4G) communication systems or IEEE 802.16 communication systems, in order to provide mobile stations with high-speed services.

FIG. 1 illustrates a conventional broadband wireless access communication system. Referring to FIG. 1, the conventional broadband wireless access communication system, e.g., the IEEE 802.16e communication system, has a multi-cell structure including a cell 101, a cell 102, a cell 103, a base station (BS) 110 for managing the cell 101, a BS 120 for managing the cell 102, and a BS 130 for managing the cell 103. In addition, the conventional broadband wireless access communication system also includes a mobile station (MS) 100. The BSs 110, 120, and 130 communicate with the MS 100 through orthogonal frequency division multiplexing/orthogonal frequency division multiple access (OFDM/OFDMA) schemes. If the MS 100 is located in a handover area of the cell, it is necessary to support the MS 100 with a handover function in order to provide mobility to the MS 100.

In the above conventional broadband wireless access communication system, the MS receives pilot channels from a plurality of BSs. Upon receiving the pilot channels from the BSs, the MS measures the intensity of the pilot channels and selects a BS transmitting the pilot channel having the highest intensity. That is, the MS selects the BS transmitting the pilot channel having the highest intensity from among the plural BSs and identifies the BS as a BS managing the MS.

FIG. 2 is a signal flowchart illustrating a conventional handover procedure of an MS. Referring to FIG. 2, the MS 100 receives a DL-MAP message, a UL-MAP message, and target BS information from a serving BS 110 in steps 200 and 202. The MS 100 measures the intensity of signals transmitted thereto from the target BSs based on the target BS information, i.e., a target BS list, in step 204. Thereafter, the MS 100 performs ranging and registration procedures in cooperation with the serving BS 110 and the target BSs 120 and 130 in step 206. That is, the MS 100 demodulates downlink signal of the serving BS 110 and first and second target BSs 120 and 130 and modulates an uplink signal for the serving BS 110. Execution of step 206 may depend on the capability of the MS 100. This will be described later in detail.

After step 206, the MS 100 transmits a handover request message to the serving BS 110 in step 208.

Upon receiving the handover request message from the MS 100, the serving BS 110 creates the target BS list based on the target BS information included in the handover request message in step 210. In addition, the serving BS 110 transmits a handover connection request message to the first and second target BSs 120 and 130 according to the target BS list in step 212. The handover connection request message includes quality of service (QoS) level and service bandwidth information requested by the MS 100.

As the handover connection request message is received in the first and second target BSs 120 and 130, the first and second target BSs 120 and 130 transmit a handover connection response message to the serving BS 110, respectively in steps 214 and 216, respectively. That is, upon receiving the handover connection request message, the first and second target BSs 120 and 130 determine if they can support the QoS level and service bandwidth included in the handover connection request message and requested by the MS 100. If it is determined that they can support the QoS level and service bandwidth requested by the MS 100, the first and second BSs 120 and 130 transmit the handover connection response message by adding ACK information thereto. However, if it is determined that they cannot support the QoS level and service bandwidth requested by the MS 100, the first and second BSs 120 and 130 transmit the handover connection response message by adding NACK information thereto. Here, it is assumed that the second target BS 130 transmits the handover connection response message to the serving BS 110 by adding ACK information to the handover connection response message in step 216.

As the handover connection response message is received in the serving BS 110, the serving BS 110 transmits a handover response message to the MS 100 in step 218. The handover response message includes information about the target BS serving as a handover BS for the MS and the frequency band used in the target BS. Upon receiving the handover response message from the serving BS 110, the MS 100 sends a message to the serving BS 110 in order to notify the serving BS 110 of the start of a handover in step 220.

The serving BS 110 transmits a handover connection confirmation message to the second target BS 130, which has been determined as the handover BS for the MS 100 in step 221. In addition, the serving BS 110 disconnects the call between the serving BS 110 and the MS 100 in step 222.

The second target BS 130 transmits DL-MAP and UL-MAP information to the MS 100 in step 224. Upon receiving the DL-MAP and UL-MAP information, the MS 100 transmits a ranging request message to the second target BS 130 in step 226, and the second target BS 130 receiving the ranging request message transmits a ranging response message to the MS 100 in step 228.

Step 206 shown in FIG. 2, i.e., the ranging and registration procedures of the MS 100 in cooperation with the serving BS 110 and the target BSs 120 and 130, can be performed or not depending on the capability of the MS 100. If the MS does not support the ranging and registration procedures, relatively long time is required for performing steps 226 and 228 of transmitting the ranging request message and ranging response message, thereby delaying the handover.

In addition, if the MS 100 simultaneously performs the modulation and demodulation operations with respect to the serving BS 110 and various target BSs 120 and 130, the MS 100 may be subject to overload.

### SUMMARY OF THE INVENTION

Accordingly, the present invention has been designed to solve the above and other problems occurring in the prior art. An object of the present invention is to provide a system and a method for enabling a mobile station (MS) to minimize time spent for performing the ranging procedure in cooperation with a target base station (BS) determined as a handover BS.

Another object of the present invention is to provide a system and a method for shortening a time required for a handover of an MS by reducing message communication between a serving BS and a target BS when the MS performs the handover.

Still another object of the present invention is to provide a system and a method for providing an MS with a list of target BSs serving as handover BSs for the MS by creating the target BS list based on downlink and uplink states between the MS and the target BSs when the MS performs a handover.

In order to accomplish the above and other objects, according to a first aspect of the present invention, there is provided a system for performing a handover in a broadband wireless access communication system. The system comprises a mobile station (MS), a serving base station (BS) for providing a currently available service to the MS and at least one target BS adjacent to the serving BS, wherein the serving BS transmits target BS information and downlink/uplink map (DL-MAP/UL-MAP) information including a neighbor ranging code identifying BSs to the MS and transmits handover information of each target BS to the MS when the serving BS receives information about the neighbor ranging code, which is transmitted to the target BS by the MS, from the MS and information for the handover from the target BS, wherein the MS receives the DL-MAP information including the neighbor ranging code information, transmits the neighbor ranging code to a BS to be served as a handover BS when the handover is determined, transmits the neighbor ranging code information, which is transmitted to the target BS, to the serving BS, and receives the information for the handover from the serving BS in order to perform the handover to the handover BS, and wherein the target BS selects the serving BS corresponding to the neighbor ranging code upon receiving the neighbor ranging code from the MS, and transmits the information for the handover to the selected serving BS.

According to a second aspect of the present invention, there is provided a method for performing a handover of a mobile station (MS) in a broadband wireless access communication system including a serving BS, target BSs adjacent to the serving BS, and the MS currently communicating with the serving BS. The method comprises the steps of: receiving neighbor ranging code information from the serving BS; transmitting the neighbor ranging code information to at least one target BS; and receiving information for the handover from the serving BS.

According to a third aspect of the present invention, there is provided a method for supporting a handover of a mobile station (MS) by using a serving base station (BS) in a broadband wireless access communication system including the serving BS, a plurality of target BSs adjacent to the serving BS, and the MS currently communicating with the serving BS. The method comprises the steps of: transmitting neighbor ranging code information to the MS; receiving the neighbor ranging code information, which is transmitted to the target BS by the MS, from the MS; receiving information for the handover including an ID of a neighbor ranging code, which is transmitted by the MS, from the target BS; and transmitting the information for the handover received from each target BS to the MS.

According to a fourth aspect of the present invention, there is provided a method for supporting a handover of a mobile station (MS) by using a target base station (BS) in a broadband wireless access communication system including a serving BS, a plurality of target BSs adjacent to the serving BS, and the MS currently communicating with the serving BS. The method comprises the steps of: receiving a neighbor ranging code from the MS; selecting a serving BS corresponding to the neighbor ranging code; and transmitting information for the handover of the MS to the selected serving BS.

### BRIEF DESCRIPTION OF THE DRAWINGS

The above and other objects, features, and advantages of the present invention will be more apparent from the following detailed description taken in conjunction with the accompanying drawings, in which:

FIG. 1 illustrates a conventional broadband wireless access communication system;

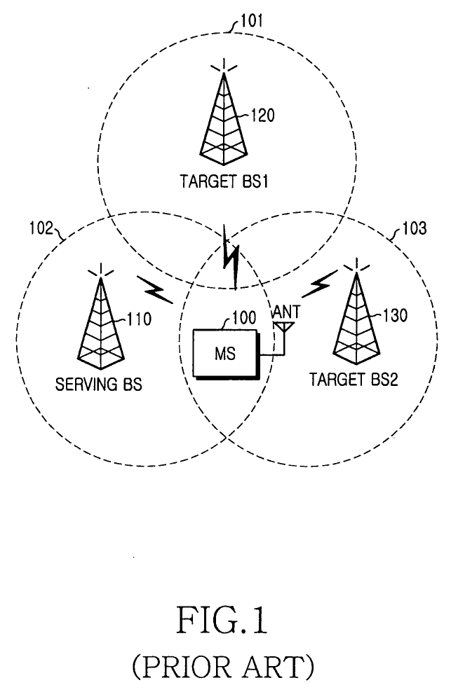

FIG. 2 is a signal flowchart illustrating a conventional handover procedure of an MS; and

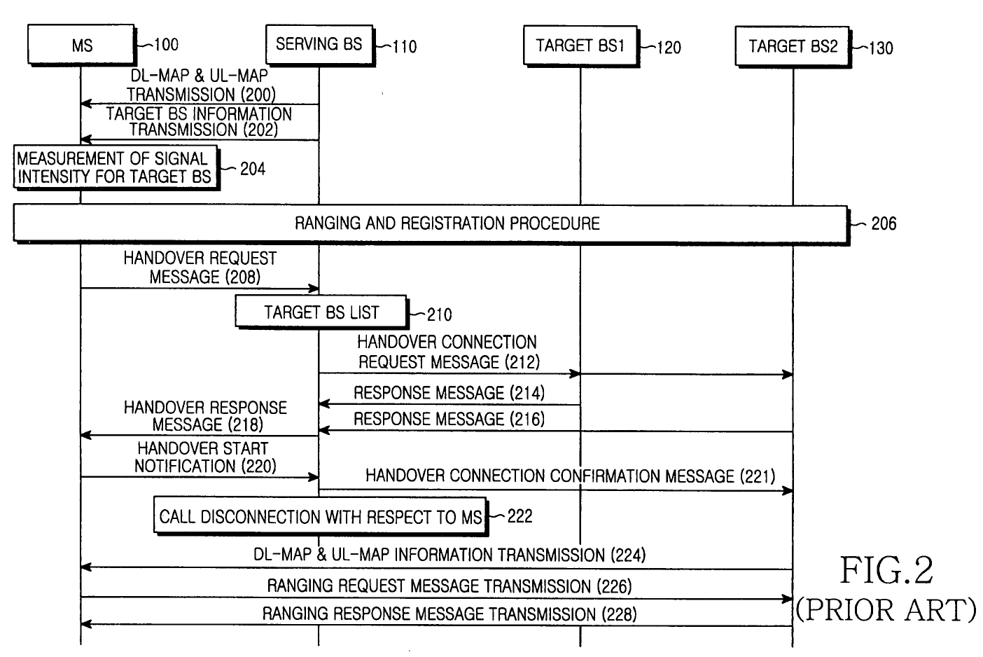

FIG. 3 is a signal flowchart illustrating a handover procedure of an MS according to an embodiment of the present invention.

### DETAILED DESCRIPTION OF THE PREFERRED EMBODIMENT

Hereinafter, preferred embodiments of the present invention will be described with reference to the accompanying drawings. In the following detailed description, a detailed description of known functions and configurations incorporated herein will be omitted when it may obscure the subject matter of the present invention.

According to the present invention, in a broadband wireless access communication system, a mobile station (MS) transmits a neighbor ranging code to at least one target base station (BS) serving as a handover BS for the MS, the target BS transmits information for a handover of the MS to a serving BS, and the serving BS collects and transmits the information for the handover to the MS. Because the MS receives the information for the handover of the MS from the serving BS, the handover of the MS can be stably achieved based on downlink and uplink states. In addition, backbone message communication between the serving BS and the target BS is reduced, such that wireless resources can be effectively utilized.

Accordingly, the present invention allocates a plurality of neighbor ranging codes to each BS. The neighbor ranging code is for identifying the BSs. Thus, at least one neighbor ranging code can be allocated to each BS. A scheme for reusing the neighbor ranging code is identical to a scheme for reusing a Walsh code in a code division multiple access (CDMA) system.

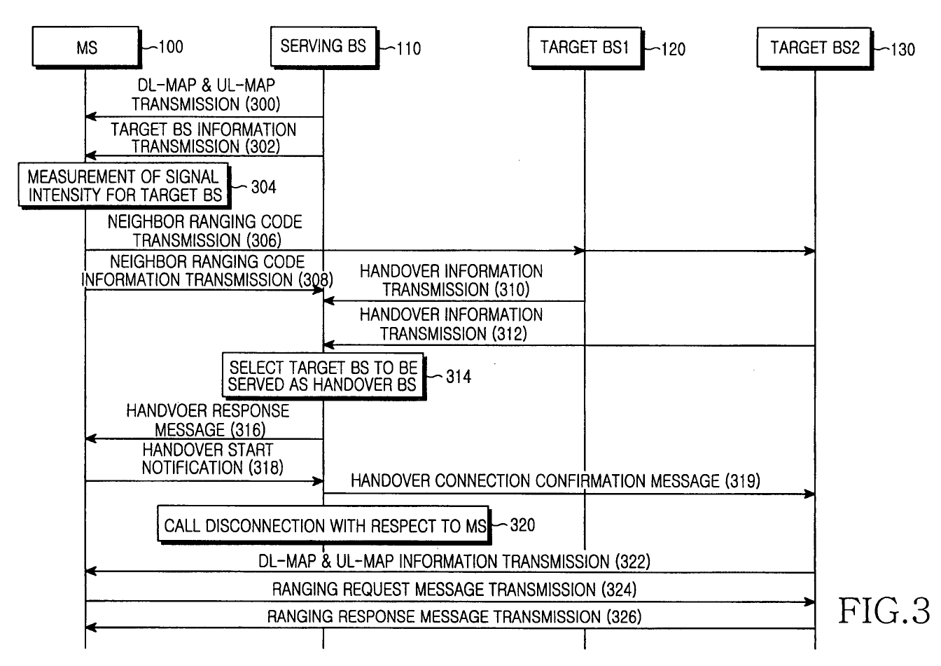

FIG. 3 is a signal flowchart illustrating a handover procedure of an MS in a broadband wireless access communication system according to an embodiment of the present invention. Referring to FIG. 3, the MS 100 receives target BS information and DL_MAP and UL_MAP messages including neighbor ranging code information from the serving BS 110 in steps 300 and 302. The MS 100 determines at least one candidate target BS to be served as a handover BS for the MS 100 based on the target BS information, i.e., the target BS list transmitted from the serving BS 110, by measuring the intensity of the signals transmitted from the serving BS and target BSs in step 304. Thereafter, the MS 100 transmits the neighbor ranging code to the target BSs 120 and 130 to be served as the handover BSs for the MS 100 in step 306 by selecting one of neighbor ranging codes transmitted thereto from the serving BS 110. In addition, the MS 100 transmits information about the neighbor ranging code transmitted to the target BSs 120 and 130 to the serving BS 110 in step 308. At this time, the neighbor ranging code information presents a predetermined neighbor ranging code (ID) transmitted to a predetermined channel or a predetermined slot (symbol).

The first and second target BSs 120 and 130 receiving the neighbor ranging code from the MS 100 can recognize the BS corresponding to the neighbor ranging code, i.e., the serving BS 110, because the BSs have their own neighbor ranging codes and the target BSs may previously recognize information about the neighbor ranging codes of the BSs.

The first and second target BSs 120 and 130 transmit information for the handover to the serving BS 110 in steps 310 and 312. The information for the handover includes a channel receiving the neighbor ranging code, a slot (symbol) receiving the neighbor ranging code, a neighbor ranging code ID, the reception intensity of an uplink, time/power adjustment information, maximum resource information related to QoS provided to the MS 100 from the target BS, and a basic/primary CID used in the target BS. The first and second target BSs 120 and 130 measure the signal intensity of the neighbor ranging code information transmitted from the MS 100 and determine the reception intensity of the uplink. The target BS to serve as a handover BS for the MS 100 is conventionally determined by measuring the signal intensity of the downlink. However, according to the present invention, the target BS to serve as the handover BS for the MS 100 is determined by taking the signal intensity of the downlink and the uplink into consideration.

In addition, the serving BS 110 identifies the MS 100 by using the neighbor ranging code ID and information about the channel and slot receiving the neighbor ranging code.

The serving BS 110 determines the target BS to serve as the handover BS for the MS 100 based on the neighbor ranging code information transmitted thereto from the MS 100 in step 308 and the information for the handover transmitted thereto from the target BSs 120 and 130 in step 314.

According to an embodiment of the present invention, it is assumed that the second target BS 130 is the handover BS for the MS 100. However, it should be noted that the serving BS 110 can determine the final target BS based on the handover information transmitted thereto from the target BSs 120 and 130 and can transmit the target BS information and the handover information to the MS 100.

In addition, it is also possible that the serving BS 110 notifies the MS 100 of the handover information transmitted from the target BSs 120 and 130 so as to enable the MS 100 to determine the final target BS.

The serving BS 110 transmits the handover response message including the above information to the MS 100 in step 316. The handover response message includes information notifying that the second target BS 130 is the handover BS for the MS 100, time/power adjustment information transmitted from the second target BS 130, and basic/primary CID used in the second target BS.

Upon receiving the handover response message, the MS 100 transmits a message notifying the start of the handover to the serving BS 110 in step 318 and the serving BS 110 transmits the handover connection confirmation message to the second target BS 130 determined as the handover BS for the MS 100 in step 319. Thereafter, the serving BS 110 disconnects the call between the serving BS 110 and the MS 100 in step 320.

As the handover connection confirmation message is received in the second target BS 130 from the serving BS 110, the second target BS 130 transmits the DL-MAP and UL_MAP messages to the MS 100 in step 322. In addition, the MS 100 receiving the DL-MAP and UL_MAP messages transmits the ranging request message to the second target BS 130 in step 324.

Upon receiving the ranging request message, the second target BS 130 transmits the ranging response message to the MS in step 326.

As described above, according to the present invention, it is possible to obtain resource allocation and updated time/power adjustment information in the target BS without simultaneously modulating/demodulating downlinks and uplinks of a plurality of BSs when the MS performs the handover. In addition, the serving BS of the present invention can create the target BS list and transmit the target BS list to the MS by taking the downlink state and the uplink state between the MS and the target BSs into consideration.

Furthermore, according to the present invention, message communication between the serving BS and the target BS is reduced when the MS performs the handover, thereby shortening the time required for the handover.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A system for performing a handover in a broadband wireless access communication system, the system comprising:
a mobile station (MS);
a serving base station (BS) for providing a currently available service to the MS; and
at least one target BS adjacent to the serving BS,
wherein the serving BS transmits target BS information and downlink/uplink map (DL-MAP/UL-MAP) information including a neighbor ranging code identifying BSs to the MS and transmits handover information of each target BS to the MS when the serving BS receives information about the neighbor ranging code, which is transmitted to the target BS by the MS, from the MS and information for the handover from the target BS,
wherein the MS receives the DL-MAP information including the neighbor ranging code information, transmits the neighbor ranging code to a BS to be served as a handover BS when the handover is determined, transmits the neighbor ranging code information, which is transmitted to the target BS, to the serving BS, and receives the information for the handover from the serving BS in order to perform the handover to the handover BS, and
wherein the target BS selects the serving BS corresponding to the neighbor ranging code upon receiving the neighbor ranging code from the MS, and transmits the information for the handover to the selected serving BS.

2. The system as claimed in claim 1, wherein the neighbor ranging code information transmitted to the serving BS comprises at least one of an ID for the neighbor ranging code transmitted to the target BS from the MS, a transmission channel number, and a transmission slot.

3. The system as claimed in claim 1, wherein the information for the handover comprises at least one of an ID for the neighbor ranging code received in the target BS, a channel receiving the neighbor ranging code, a slot receiving the neighbor ranging code, a reception intensity of a reverse link of the MS received in the target BS, time adjustment information, power adjustment information, resources to be provided to the MS performing the handover to the target BS, and quality of service (QoS) level.

4. A method for performing a handover of a mobile station (MS) in a broadband wireless access communication system including a serving BS, target BSs adjacent to the serving BS, and the MS currently communicating with the serving BS, the method comprising the steps of:
receiving neighbor ranging code information from the serving BS;
transmitting the neighbor ranging code information to at least one target BS; and
receiving information for the handover from the serving BS.

5. The method as claimed in claim 4, wherein the neighbor ranging code information is received through a DL-MAP message and each BS uses at least one unique neighbor ranging code.

6. The method as claimed in claim 4, wherein the information for the handover includes at least one of an ID for the neighbor ranging code received in the target BS, a channel receiving the neighbor ranging code, a slot receiving the neighbor ranging code, a reception intensity of a reverse link of the MS received in the target BS, time adjustment information, power adjustment information, frequency resources to be provided to the MS performing the handover to the target BS, and quality of service (QoS) level.

7. The method as claimed in claim 4, further comprising a step of transmitting the neighbor ranging code information, which is transmitted to the target BS, to the serving BS.

8. A method for supporting a handover of a mobile station (MS) by using a serving base station (BS) in a broadband wireless access communication system including the serving BS, a plurality of target BSs adjacent to the serving BS, and the MS currently communicating with the serving BS, the method comprising the steps of:
transmitting neighbor ranging code information to the MS;
receiving the neighbor ranging code information, which is transmitted to the target BS by the MS, from the MS;
receiving information for the handover including an ID of a neighbor ranging code, which is transmitted by the MS, from the target BS; and
transmitting the information for the handover received from each target BS to the MS.

9. The method as claimed in claim 8, wherein the neighbor ranging code is transmitted through a DL-MAP message and each BS uses at least one unique neighbor ranging code.

10. The method as claimed in claim 8, wherein the information for the handover received from the target BS includes at least one of an ID for the neighbor ranging code received in the target BS, a channel receiving the neighbor ranging code, a slot receiving the neighbor ranging code, a reception intensity of a reverse link of the MS received in the target BS, time adjustment information, power adjustment information, frequency resources to be provided to the MS performing the handover to the target BS, and quality of service (QoS) level.

11. A method for supporting a handover of a mobile station (MS) by using a target base station (BS) in a broadband wireless access communication system including a serving BS, a plurality of target BSs adjacent to the serving BS, and the MS currently communicating with the serving BS, the method comprising the steps of:
receiving a neighbor ranging code from the MS;
selecting a serving BS corresponding to the neighbor ranging code; and
transmitting information for the handover of the MS to the selected serving BS.

12. The method as claimed in claim 11, wherein a BS using the neighbor ranging code transmitted from the MS is selected as the serving BS based on predetermined neighbor ranging code information of each BS.

13. The method as claimed in claim 11, wherein the information for the handover transmitted to the serving BS includes at least one of an ID for the neighbor ranging code transmitted to the target BS from the MS, a channel receiving the neighbor ranging code, a slot receiving the neighbor ranging code, a reception intensity of a reverse link of the MS received in the target BS, time adjustment information, power adjustment information, frequency resources to be provided to the MS performing the handover to the target BS, and quality of service (QoS) level.
